(19) United States
(12) Patent Application Publication
(10) Pub. No.: US 2009/0236932 A1
(43) Pub. Date: Sep. 24, 2009

(54) ELECTROSTATIC ACTING DEVICE

(75) Inventor: Naoteru Matsubara, Ichinomiya-shi (JP)

Correspondence Address: DITTHAVONG MORI & STEINER, P.C., 918 Prince St., Alexandria, VA, 22314, US

(73) Assignee: SANYO Electric Co., Ltd., Osaka (JP)

(21) Appl. No.: 12/409,916

(22) Filed: Mar. 24, 2009

(30) Foreign Application Priority Data
Mar. 24, 2008 (JP) 2008-76741JP

(51) Int. Cl. H02N 1/00

(52) U.S. Cl. 310/309

(57) ABSTRACT

An electrostatic acting device is so formed that a distance between partial regions of a first electrode of a first substrate and a second electrode of a second substrate is smaller than an interelectrode distance controlled by a gap control portion.

### CROSS-REFERENCE TO RELATED APPLICATIONS

The priority application number JP2008-076741, Electrostatic Acting Device, Mar. 24, 2008, Naoteru Matsubara, upon which this patent application is based is hereby incorporated by reference.

### BACKGROUND OF THE INVENTION

1. Field of the Invention

The present invention relates to an electrostatic acting device, and more particularly, it relates to an electrostatic acting device comprising a first substrate formed with a first electrode and a second substrate formed with a second electrode.

2. Description of the Background Art

An electrostatic acting device comprising a first substrate formed with a first electrode and a second substrate formed with a second electrode is known in general.

An electret power generator (electrostatic acting device) comprising a movable portion (first substrate) provided with an electrode (first electrode) having conductivity and a fixed portion (second substrate) provided with an electrode (second electrode) made of an electret holding charges is disclosed in general. In general, the electrodes provided on the movable portion and the fixed portion respectively are so arranged at a constant interval (gap between the electrodes) therebetween as to be opposed to each other, and the movable portion is so supported as to be held between spring members. Thus, the electret power generator is so formed as to generate power by causing electrostatic induction between the opposed electrodes when the movable portion vibrates in a direction parallel to the fixed portion.

### SUMMARY OF THE INVENTION

An electrostatic acting device according to a first aspect of the present invention comprises a first substrate formed with a first electrode, a second substrate provided to be opposed to the first substrate at a prescribed interval, formed to be movable relatively to the first substrate and formed with a second electrode, and a gap control portion controlling an interelectrode gap between the first electrode and the second electrode, wherein a distance between at least partial regions of the first electrode of the first substrate and the second electrode of the second substrate is smaller than an interelectrode distance controlled by the gap control portion.

A power generator according to a second aspect of the present invention comprises a first substrate formed with a first electrode, a second substrate provided to be opposed to the first substrate at a prescribed interval, formed to be movable relatively to the first substrate and formed with a second electrode, and a gap control portion controlling an interelectrode gap between the first electrode and the second electrode, to be capable of generating power by electrostatic induction due to relative movement of the first substrate and the second substrate, wherein a distance between at least partial regions of the first electrode of the first substrate and the second electrode of the second substrate is smaller than an interelectrode distance controlled by the gap control portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing an overall structure of a power generator according to a first embodiment of the present invention;

FIG. 2 is a sectional view taken along the line 200-200 in FIG. 1;

FIG. 3 is a plan view showing an overall structure of a power generator according to a second embodiment of the present invention;

FIG. 4 is a sectional view taken along the line 200a-200a in FIG. 3;

FIG. 5 is a plan view showing an overall structure of a power generator according to a third embodiment of the present invention;

FIG. 6 is a sectional view taken along the line 200b-200b in FIG. 5; and

FIGS. 7 and 8 are diagrams for illustrating a modification of the present invention.

### DESCRIPTION OF THE PREFERRED EMBODIMENTS

Embodiments of the present invention will be hereinafter described with reference to the drawings.

### First Embodiment

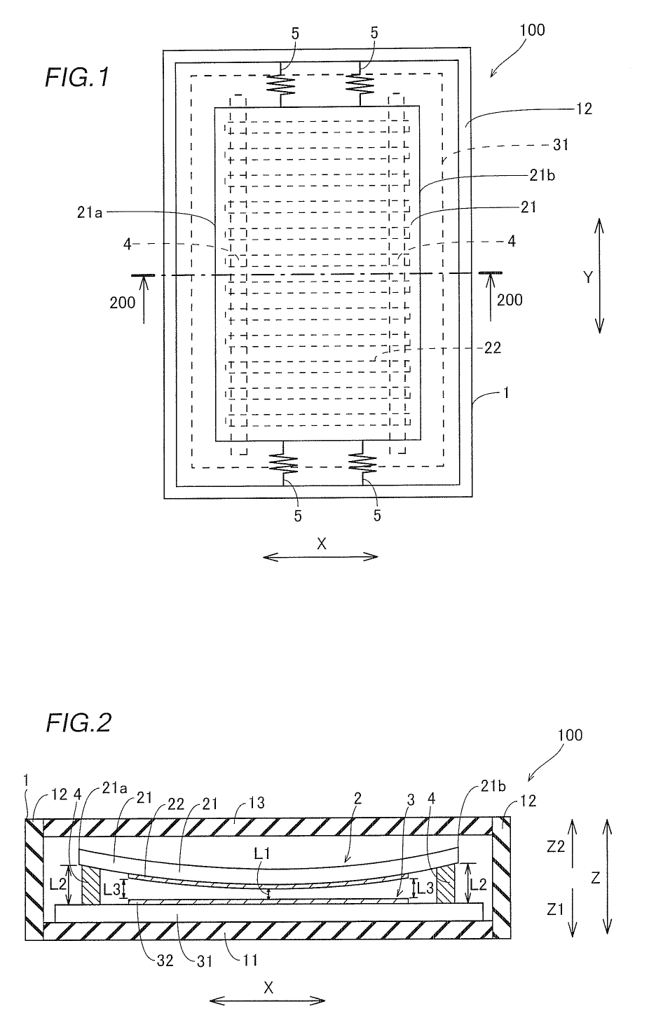

A structure of a power generator 100 according to a first embodiment of the present invention will be now described with reference to FIGS. 1 and 2. The power generator 100 is an example of the “electrostatic acting device” in the present invention.

The power generator 100 according to the first embodiment of the present invention comprises a housing 1, a movable portion 2, a fixed portion 3, two gap control portions 4 and spring members 5 (see FIG. 1) made of a coil spring, as shown in FIG. 2.

The housing 1 includes a platelike support member 11, a support 12 and a lid portion 13, as shown in FIGS. 1 and 2. The fixed portion 3 is placed on the support member 11. The support 12 is so formed as to enclose the support member 11 in plan view and to extend a direction (direction Z) perpendicular to an extensional direction (directions X and Y) of the support member 11. The lid portion 13 is arranged on an upper portion of the support 12 to close an opening portion of the support 12.

The movable portion 2 includes a movable substrate 21 made of Si (silicon) and electrets 22 formed on an arrow Z1 direction side of the movable substrate 21, as shown in FIG. 2. Each of the electrets 22 is formed by injecting charges by corona discharge after forming a multilayer film of an SiO₂ film having a thickness of about 1 μm formed on the movable substrate 21 and an organic SOG film having a thickness of about 0.3 μm, formed on this SiO₂ film. The quantity of discharged charges at this time is about 2×10¹⁴ cm⁻². The movable substrate 21 is an example of the “first substrate” in the present invention, and the electrets 22 are examples of the “first electrode” in the present invention.

According to the first embodiment, each electret 22 formed by the multilayer film of the SiO₂ film and the organic SOG film has a function as a film applying compressive stress to the movable substrate 21. More specifically, a thermal treatment process is performed before injecting charges by corona discharge in formation of the electrets 22. At this time, a thermal expansion coefficient of each SiO₂ film (in a state before charge injection) is different from that of the movable substrate 21 made of Si, and hence the SiO₂ film is so deformed as to apply such stress (compressive stress) that compressing the movable substrate 21. In this case, while the SiO₂ film is so deformed as to expand in the direction X, the movable substrate 21 is so deformed as to contract in the direction X following expansion of the SiO₂ film. Then the SiO₂ film is made as an electret by charge injection in a state of applying compressive stress to the movable substrate 21. Accordingly, each electret 22 (SiO₂ film made as an electret) is so formed as to be brought into the state of applying compressive stress to the movable substrate 21. Thus, according to the first embodiment, the movable substrate 21 and the electrets 22 are so formed as to have substantial convex shapes on the arrow Z1 direction side (on a fixed substrate 31 side) and to be entirely warped in the direction Z. The movable substrate 21 and the electrets 22 are so formed as to be warped in a direction (direction X) intersecting with a relative movement direction (direction Y) of the movable substrate 21 to the fixed substrate 31 in plan view. Each electret 22 has both functions as a film applying compressive stress to the movable substrate 21 and an electrode.

The fixed portion 3 includes the fixed substrate 31 made of glass, provided on the support member 11, and the collectors 32 made of Al, formed on a surface of the fixed substrate 31 on an arrow Z2 direction side. The fixed substrate 31 is an example of the “second substrate” in the present invention. The collectors 32 are examples of the “second electrode” in the present invention. The fixed substrate 31 is so provided as to be opposed to the movable substrate 21. The movable substrate 21 is so formed as to be relatively movable in the direction Y (see FIG. 2) with respect to the fixed substrate 31.

According to the first embodiment, the two gap control portions 4 are made of Si, SiO₂ or the like, and has a function of controlling an interelectrode distance (gap) in the direction Z between the electrets 22 of the movable substrate 21 and the collectors 32 of the fixed substrate 31, as shown in FIG. 2. More specifically, the two gap control portions 4 are so arranged in the vicinities of ends 21a and 21b of the movable substrate 21 on the direction X side as to extend in the direction Z respectively and so formed as to control the interelectrode distance (gap) in the direction Z between the electrets 22 and the collectors 32 by controlling lengths of the gap control portions 4.

According to the first embodiment, a length L1 between the vicinity of the central portion of each electret 22 of the movable substrate 21 and the vicinity of the central portion of the corresponding collector 32 of the fixed substrate 31 is rendered smaller than a length L2 between substrates controlled by the gap control portions 4. According to the first embodiment, the length L1 between the vicinity of the central portion of each electret 22 and the vicinity of the central portion of the corresponding collector 32 is rendered smaller than a distance L3 between the vicinity of each of the peripheral portions of each electret 22 and the vicinity of each of the peripheral portions of the corresponding collector 32. A region where the distance between the vicinity of the central portion of each electret 22 of the movable substrate 21 and the vicinity of the central portion of the corresponding collector 32 of the fixed substrate 31 is the smallest is a region in a direction along the relative movement direction (direction Y) of the movable substrate 21 to the fixed substrate 31 in plan view.

As shown in FIG. 1, the four spring members 5 are provided for holding the movable substrate 21 on the support 12 of the housing 1. The spring members 5 expand/contract, so that the movable substrate 21 can vibrate in the direction Y with respect to the fixed substrate 31.

A power generating operation of the power generator 100 according to the first embodiment of the present invention will be now described with reference to FIGS. 1 and 2.

As shown in FIGS. 1 and 2, electrostatic induction occurs between the electrets 22 and the collectors 32 opposed to each other in a state where the movable substrate 21 stands still in the housing 1, so that charges are stored in the collectors 32. Then, the power generator 100 vibrates in the direction Y, so that the electrets 22 move parallel to the collectors 32. Thus, the quantity of charges induced in the collectors 32 due to electrostatic induction is changed. Then, a current is generated in a load (not shown) connected to the collectors 32.

According to the first embodiment, as hereinabove described, the length (L1) between the vicinity of the central portion of each electret 22 of the movable substrate 21 and the vicinity of the central portion of the corresponding collector 32 of the fixed substrate 31 is rendered smaller than the length (L2) controlled by the gap control portions 4. Thus, the interelectrode gap (distance) between the vicinity of the central portion of each electret 22 and the vicinity of the central portion of the corresponding collector 32 is reduced with compared with a case of always holding the distance between the electrodes at a constant interval, and hence the quantity of power generation can be further increased.

According to the first embodiment, as hereinabove described, the vicinity of the central portion of the movable substrate 21 is warped, whereby the length (L1) between the vicinity of the central portion of each electret 22 of the movable substrate 21 and the vicinity of the central portion of the corresponding collector 32 of the fixed substrate 31 is rendered smaller than the length (L2) controlled by the gap control portions 4. Thus, the interelectrode gap (distance) between the vicinity of the central portion of the movable substrate 21 and the vicinity of the central portion of the fixed substrate 31 can be reduced.

According to the first embodiment, as hereinabove described, the movable substrate 21 is so formed as to be warped in the direction (direction X) intersecting with the relative movement direction (direction Y) of the movable substrate 21 to the fixed substrate 31 in plan view. Thus, the length (L1) between the vicinity of the central portion of each electret 22 of the movable substrate 21 and the vicinity of the central portion of the corresponding collector 32 of the fixed substrate 31 can be rendered smaller than the length (L2) controlled by the gap control portions 4.

According to the first embodiment, as hereinabove described, the length (L1) between the vicinity of the central portion of each electret 22 of the movable substrate 21 and the vicinity of the central portion of the corresponding collector 32 of the fixed substrate 31 is rendered smaller than the distance (L3) between the vicinity of each of the peripheral portions of each electret 22 of the movable substrate 21 and the vicinity of each of the peripheral portions of the corresponding collector 32 of the fixed substrate 31. Thus, the interelectrode gap between the vicinities of the central portions of each electret 22 and the corresponding collector 32 is rendered smaller than the interelectrode gap between the vicinities of the peripheral portions of the electrets 22 and the corresponding collector 32. Consequently, the quantity of power generation in the vicinities of the central portions of the electrets 22 and the collectors 32 can be rendered larger than the quantity of power generation in the vicinities of the peripheral portions of the electrets 22 and the collectors 32. Accordingly, the overall quantity of power generation can be increased.

According to the first embodiment, as hereinabove described, the region where the distance between the vicinity of the central portion of each electret 22 of the movable substrate 21 and the vicinity of the central portion of the corresponding collector 32 of the fixed substrate 31 is the smallest is the region in the direction along the relative movement direction (direction Y) of the movable substrate 21 to the fixed substrate 31 in plan view. Thus, the interelectrode gap in the direction Y between the vicinities of the central portions of each electret 22 and the corresponding collector 32 is rendered smaller than the interelectrode gap in the direction Y between the vicinities of the peripheral portions of the electret 22 and the corresponding collector 32. Consequently, the quantity of power generation generated in the vicinities of the central portions of the electrets 22 and the collectors 32 can be rendered larger than the quantity of power generation generated in the vicinities of the peripheral portions of the electrets 22 and the collectors 32.

According to the first embodiment, as hereinabove described, the movable substrate 21 is formed to entirely have a substantial convex shape toward the collectors 32. Thus, the interelectrode gap (distance) between the vicinities of the central portions of each electret 22 and the corresponding collector 32 can be reliably reduced as compared with a case of linearly forming the movable substrate 21, and hence the quantity of power generation can be easily increased.

According to the first embodiment, as hereinabove described, the SiO₂ film applying compressive stress to the movable substrate 21 is formed on the surface of the movable substrate 21 on the fixed substrate 31 side (arrow Z1 direction side). Thus, the movable substrate 21 can be easily deflected to be convex toward the collectors 32. Thus, the interelectrode gap (distance) between the vicinities of the central portions of each electret 22 and the corresponding collectors 32 can be easily reduced as compared with the case of linearly forming the movable substrate 21.

According to the first embodiment, as hereinabove described, the movable substrate 21 is so formed as to be warped to the fixed substrate 31 side by the SiO₂ films applying the compressive stress. Thus, the movable substrate 21 and the electrets 22 can be easily warped through the thermal treatment process, and hence the interelectrode gap (L1) between the vicinities of the central portions of each electret 22 and the corresponding collector 32 can be easily reduced as compared with a case where the movable substrate 21 is planarized.

### Second Embodiment

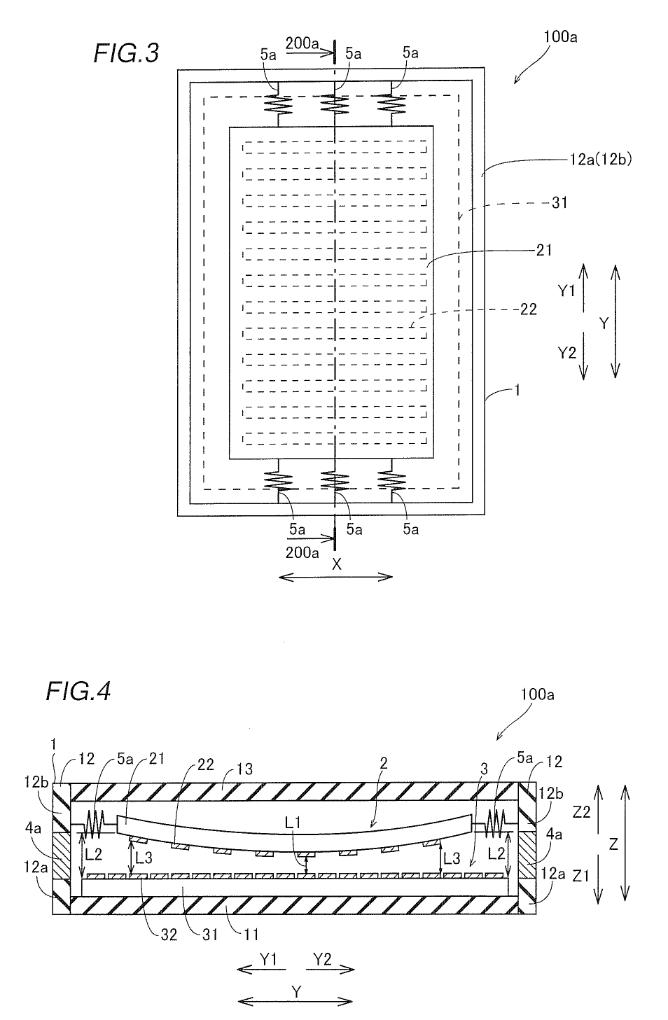

Referring to FIGS. 3 and 4, a gap control portion 4a is formed to be arranged in a support 12 in a power generator 100a according to a second embodiment, dissimilarly to the first embodiment where the gap control portions 4 are arranged between the movable substrate 21 and the fixed substrate 31. The power generator 100a is an example of the “electrostatic acting device” in the present invention.

In the power generator 100a according to the second embodiment, the gap control portion 4a is so arranged as to be held between a first support 12a provided on a support member 11 side and a second support 12b provided on a lid portion 13 side, as shown in FIG. 4. The movable portion 2 is supported on a second support 12b side by spring members 5a. Thus, interelectrode gaps between electrets 22 of the movable substrate 21 and collectors 32 of the fixed substrate 31 are controlled by controlling a length of a gap control portion 4a.

According to the second embodiment, each electret 22 is so formed as to be brought into a state of applying such stress (compressive stress) that compressing the movable substrate 21 in a direction Y dissimilarly to the first embodiment. Thus, the movable portion 2 is so formed as to have a substantial convex shape on an arrow Z1 direction side (fixed substrate 31 side) and to be entirely warped in a direction Z. The movable substrate 21 and the electrets 22 are so formed as to be warped in a relative movement direction (direction Y) of the movable substrate 21 to the fixed substrate 31 in plan view.

The remaining structure and power generating operation of the power generator 100a according to the second embodiment are similar to those of the first embodiment.

According to the second embodiment, as hereinabove described, an interelectrode gap (distance) between the vicinities of central portions of each electret 22 and the corresponding collector 32 can be easily rendered smaller than an interelectrode gap between the vicinities of peripheral portions of each electret 22 and the corresponding collector 32 similarly to the first embodiment, even when the electrets 22 apply such stress (compressive stress) that compressing the movable substrate 21 in the direction Y to the movable substrate 21, and hence the quantity of power generation can be increased.

According to the second embodiment, as hereinabove described, the interelectrode gaps between the electrets 22 and the collectors 32 can be easily controlled also when the gap control portion 4a is held between the first support 12a and the second support 12b.

The remaining effects of the second embodiment are similar to those of the first embodiment.

### Third Embodiment

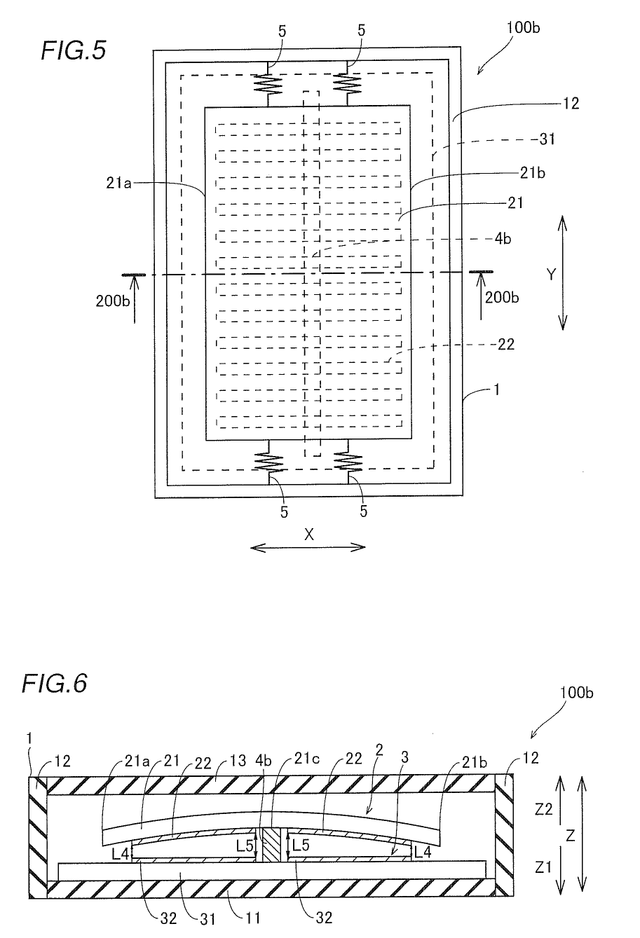

Referring to FIGS. 5 and 6, a gap control portion 4b is formed to be arranged between regions in the vicinities of central portions of a movable substrate 21 and a fixed substrate 31 in a power generator 100b according to a third embodiment, dissimilarly to the first embodiment where the gap control portions 4 are arranged between the regions in the vicinities of the peripheral portions of the movable substrate 21 and the fixed substrate 31. The power generator 100b is an example of the “electrostatic acting device” in the present invention.

In the power generator 100b according to the third embodiment, a single gap control portion 4b is so provided as to extend in a direction Y as shown in FIGS. 5 and 6. This gap control portion 4b is arranged between the regions in the vicinities of the central portions of the movable substrate 21 and the fixed substrate 31, as shown in FIG. 6. According to the third embodiment, electrets 22 are formed on a surface of the movable substrate 21 on an arrow Z1 direction side. Each electret 22 is made of an SiO₂ film and an organic SOG film which are materials having thermal expansion coefficients smaller than that of the movable substrate 21.

The electrets 22, which are formed on the surface of the movable substrate 21 on the arrow Z1 direction side, are so formed as to be brought into a state of applying stress expanding the movable substrate 21 in a direction Y. More specifically, a case of expansion and a case of contraction depend on a method of forming a film of an electret or a condition of a thermal treatment process after forming the film of the electret. According to the third embodiment, the SiO₂ films are formed to be contracted, so that the SiO₂ films apply such stress (such stress that expanding the movable substrate 21) pulling the movable substrate 21, dissimilarly to the first embodiment where the SiO₂ films are expanded. Thus, the movable portion 2 is so formed as to have a substantial convex shape on an arrow Z2 direction side (side opposite to the fixed substrate 31) and to be entirely warped in a direction Z. The movable substrate 21 and the electrets 22 are so formed as to be warped in a direction (direction X) intersecting with a relative movement direction (direction Y) of the movable substrate 21 to the fixed substrate 31 in plan view.

Thus, a length L4 between the vicinity of the peripheral portions of each electret 22 of the movable substrate 21 and the vicinity of the peripheral portions of the corresponding collector 32 of the fixed substrate 31 is rendered smaller than a length L5 between the vicinity of the central portion of the movable substrate 21 and the vicinity of the electret 22 of the central portion of the collector 32 of the fixed substrate 31 according to the third embodiment. A region where the distance between the vicinity of each of the peripheral portion of each electret 22 of the movable substrate 21 and the vicinity of each of the peripheral portion of the corresponding collector 32 of the fixed substrate 31 is the smallest is a region in a direction along the relative movement direction (direction Y) of the movable substrate 21 to the fixed substrate 31 in plan view.

The remaining structure of the third embodiment is similar to that of the first embodiment.

According to the third embodiment, as hereinabove described, the length L4 between the vicinity of the peripheral portions of each electret 22 of the movable substrate 21 and the vicinity of the peripheral portions of the corresponding collector 32 of the fixed substrate 31 is rendered smaller than the length L5 between the vicinity of the central portion of the electret 22 of the movable substrate 21 and the vicinity of the central portion of the collector 32 of the fixed substrate 31. Thus, an interelectrode gap between the vicinity of the peripheral portions of each electret 22 and the vicinity of the peripheral portions the corresponding collector 32 is reduced as compared with a case of holding a distance of the electrodes at a constant interval, and hence the quantity of power generation can be increased.

According to the third embodiment, as hereinabove described, the gap control portion 4b is arranged in the vicinities of the central portions of the electrets 22 of the movable substrate 21 and the collectors 32 of the fixed substrate 31, whereby the distances between the vicinities of the central portions of the electrets 22 of the movable substrate 21 and the vicinities of the central portions of the collectors 32 of the fixed substrate 31 are held constant. Thus, the interelectrode gap between the vicinities of the central portions of each electret 22 of the movable substrate 21 and the corresponding collector 32 of the fixed substrate 31 can be controlled.

According to the third embodiment, as hereinabove described, the region where the distance (L4) between the vicinity of the peripheral portion of each electret 22 of the movable substrate 21 and the vicinity of the peripheral portion of the corresponding collector 32 of the fixed substrate 31 is the smallest is a region in the direction along the relative movement direction (direction Y) of the movable substrate 21 to the fixed substrate 31 in plan view. Thus, the interelectrode gap in the direction Y between the vicinities of the peripheral portions of each electret 22 and the corresponding collector 32 is rendered smaller than the interelectrode gap in the direction Y between the vicinities of the central portions of the electret 22 and the corresponding collector 32. Consequently, the quantity of power generation generated in the vicinities of the peripheral portions of the electrets 22 and the collectors 32 can be rendered larger than the quantity of power generation generated in the vicinities of the central portions of the electrets 22 and the collectors 32.

According to the third embodiment, as hereinabove described, the movable portion 21 is so formed as to have a substantial convex shape on the side opposite to the fixed substrate 31. Thus, the interelectrode gaps (distances) between the peripheral portions of the convex movable substrate 21 and the fixed substrate 31 can be reliably reduced.

According to the third embodiment, as hereinabove described, the movable substrate 21 is so formed as to be warped to a side opposite to the fixed substrate 31 by the SiO₂ film applying compressive stress. Thus, the movable substrate 21 and the electrets 22 can be easily warped through the thermal treatment process, and hence the interelectrode gap (L4) between the vicinities of the peripheral portions of each electret 22 and the corresponding collector 32 can be reduced as compared with a case where the movable substrate 21 is planarized.

The remaining effects of the third embodiment are similar to those of the first embodiment.

Although the present invention has been described and illustrated in detail, it is clearly understood that the same is by way of illustration and example only and is not to be taken by way of limitation, the spirit and scope of the present invention being limited only by the terms of the appended claims.

For example, while the film made of SiO₂ is employed as the film applying stress to the movable substrate in each of the aforementioned first to third embodiments, the present invention is not restricted to this but a film made of a material other than SiO₂ may be applicable so far as the film applies stress to the movable substrate.

While the movable substrate is made of Si in each of the aforementioned first to third embodiments, the present invention is not restricted to this but a movable substrate made of a material other than Si may be formed.

While the fixed substrate is made of glass in each of the aforementioned first to third embodiments, the present invention is not restricted to this but the fixed substrate may be formed by a material other than glass.

While the movable substrate is curved in each of the aforementioned first to third embodiments, the present invention is not restricted to this but a structure in which the fixed substrate is curved may be applicable.

While the gap control portion(s) is(are) made of Si or SiO₂ in each of the aforementioned first to third embodiments, the present invention is not restricted to this but the gap control portion may be formed by a hard organic resin material or a hard metal material, for example, so far as the material is hard enough not to change the thickness of the material.

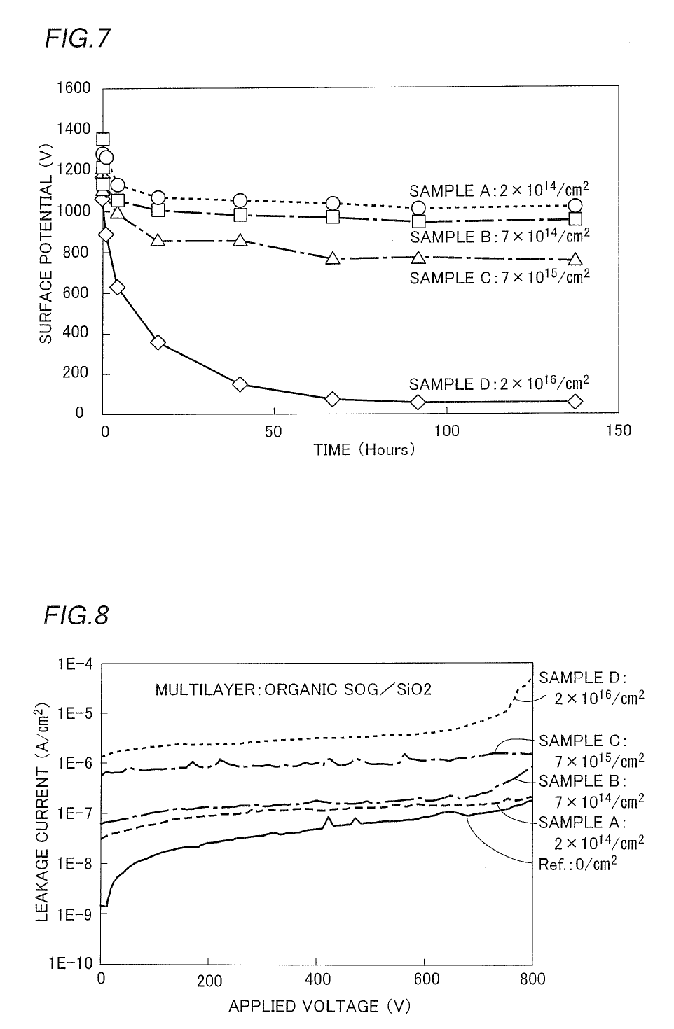

While the quantity of discharged charges in injecting charges is 2×10¹⁴ cm⁻² as a condition where the film (SiO₂ and organic SOG) on the movable substrate is made as an electret in each of the aforementioned first to third embodiments, the present invention is not restricted to this but charges injection may be performed under a condition of the different quantity of discharged charges. Results of evaluation of samples (A to D) prepared under conditions of the different quantities of discharged charges will be hereinafter described. More specifically, a sample A made of an electret formed under a condition of the quantity of discharged charges of 2×10¹⁴ cm², a sample B made of an electret formed under a condition of the quantity of discharged charges of 7×10¹⁴ cm⁻², a sample C made of an electret formed under a condition of the quantity of discharged charges of 7×10¹⁵ cm⁻² and a sample D made of an electret formed under a condition of the quantity of discharged charges of 2×10¹⁶ cm⁻² are formed. FIG. 7 shows a diagram showing results of changes of surface potentials with time in storing the aforementioned samples A to D in the atmosphere. It is understood from the results of FIG. 7 that, in the samples A and B, the quantities of discharged charges of which are low, the surface potentials thereof are slightly reduced at an initial stage, but are stabilized at high surface potentials after tens of hours. In the sample D, the quantity of discharged charges of which is high, on the other hand, the surface potential thereof was reduced due to aged deterioration in the atmosphere and most of accumulated charges disappeared. FIG. 8 is a current-voltage characteristics diagram of the electrets of the samples A to D and a sample (ReF.) where charges are not injected. From the results of FIG. 8, it has been proved that a leakage current is increased as the quantity of discharged charges of the sample is larger (in other words, aged deterioration is larger). The reason of a leakage current of an insulating film generally includes “tunneling”, “introduction of impurity level” and “introduction of defect level”. In this case, it can be presumed from the points of a large actual film thickness and charge injection, that is, energy is physically given, that the reason is “leakage current due to introduction of defect level”. Accordingly, it is important to control discharge of charge injection while suppressing defects in order to form an electret comprising high stable characteristics. As an example of it, it can be said that minimizing the quantity of discharged charges is effective.

What is claimed is:

1. An electrostatic acting device comprising:
a first substrate formed with a first electrode;
a second substrate provided to be opposed to said first substrate at a prescribed interval, formed to be movable relatively to said first substrate and formed with a second electrode; and
a gap control portion controlling an interelectrode gap between said first electrode and said second electrode, wherein
a distance between at least partial regions of said first electrode of said first substrate and said second electrode of said second substrate is smaller than an interelectrode distance controlled by said gap control portion.

2. The electrostatic acting device according to claim 1, wherein
the distance between at least the partial regions of said first electrode of said first substrate and said second electrode of said second substrate is smaller than the interelectrode distance controlled by said gap control portion by warping either said first substrate or said second substrate.

3. The electrostatic acting device according to claim 2, wherein
either said first substrate or said second substrate is formed to be warped in a direction along a relative movement direction of said first substrate to said second substrate in plan view.

4. The electrostatic acting device according to claim 2, wherein
either said first substrate or said second substrate is formed to be warped in a direction intersecting with a relative movement direction of said first substrate to said second substrate in plan view.

5. The electrostatic acting device according to claim 1, wherein
a distance between the vicinity of a central portion of said first electrode of said first substrate and the vicinity of a central portion of said second electrode of said second substrate is smaller than a distance between the vicinity of a peripheral portion of said first electrode of said first substrate and the vicinity of a peripheral portion of said second electrode of said second substrate.

6. The electrostatic acting device according to claim 5, wherein
a region where a distance between the vicinity of the central portion of said first electrode of said first substrate and the vicinity of the central portion of said second electrode of said second substrate is the smallest is a region in a direction along a relative movement direction of said first substrate to said second substrate in plan view.

7. The electrostatic acting device according to claim 1, wherein
a distance between the vicinity of a peripheral portion of said first electrode of said first substrate and the vicinity of a peripheral portion of said second electrode of said second substrate is smaller than a distance between the vicinity of a central portion of said first electrode of said first substrate and the vicinity of a central portion of said second electrode of said second substrate.

8. The electrostatic acting device according to claim 7, wherein
said gap control portion is arranged in the vicinity of the central portions of said first substrate and said second substrate.

9. The electrostatic acting device according to claim 7, wherein
a region where the distance between the vicinity of the peripheral portion of said first electrode of said first substrate and the vicinity of the peripheral portion of said second electrode of said second substrate is the smallest is a region in a direction along a relative movement direction of said first substrate to said second substrate in plan view.

10. The electrostatic acting device according to claim 1, wherein
said first substrate has a substantial convex shape entirely.

11. The electrostatic acting device according to claim 10, wherein
said first substrate is formed to have the substantial convex shape on a side of said second substrate.

12. The electrostatic acting device according to claim 10, wherein
said first substrate is formed to have the substantial convex shape on a side opposite to said second substrate.

13. The electrostatic acting device according to claim 1, wherein
a film applying stress to said first substrate is formed on a surface of said first substrate on a side of said second substrate.

14. The electrostatic acting device according to claim 13, wherein
said first substrate is formed to be warped to the side of said second substrate or a side opposite to said second substrate by said film applying stress.

15. The electrostatic acting device according to claim 13, wherein
said film applying stress is formed by a material having a thermal expansion coefficient smaller than that of said first substrate.

16. The electrostatic acting device according to claim 1, wherein
said first electrode is an electret film and said second electrode is a collector.

17. A power generator comprising:
a first substrate formed with a first electrode;
a second substrate provided to be opposed to said first substrate at a prescribed interval, formed to be movable relatively to said first substrate and formed with a second electrode; and
a gap control portion controlling an interelectrode gap between said first electrode and said second electrode,
to be capable of generating power by electrostatic induction due to relative movement of said first substrate and said second substrate, wherein
a distance between at least partial regions of said first electrode of said first substrate and said second electrode of said second substrate is smaller than an interelectrode distance controlled by said gap control portion.

18. The power generator according to claim 17, wherein
the distance between at least the partial regions of said first electrode of said first substrate and said second electrode of said second substrate is smaller than the interelectrode distance controlled by said gap control portion by warping either said first substrate or said second substrate.

19. The power generator according to claim 18, wherein
a distance between the vicinity of a central portion of said first electrode of said first substrate and the vicinity of a central portion of said second electrode of said second substrate is smaller than a distance between the vicinity of a peripheral portion of said first electrode of said first substrate and the vicinity of a peripheral portion of said second electrode of said second substrate.

20. The power generator according to claim 18, wherein
a distance between the vicinity of a peripheral portion of said first electrode of said first substrate and the vicinity of a peripheral portion of said second electrode of said second substrate is smaller than a distance between the vicinity of a central portion of said first electrode of said first substrate and the vicinity of a central portion of said second electrode of said second substrate.
